(19) United States
(12) Patent Application Publication
(10) Pub. No.: US 2020/0386328 A1
(43) Pub. Date: Dec. 10, 2020

(54) COOLANT VALVE FOR ENGINE COOLING SYSTEM

(71) Applicant: GM Global Technology Operations LLC, Detroit, MI (US)

(72) Inventors: Michael A. Smith, Clarkston, MI (US); Scott K. Wilson, Oxford, MI (US); James B. Hicks, Washington Township, MI (US); Eugene V. Gonze, Pinckney, MI (US)

(21) Appl. No.: 16/433,653

(22) Filed: Jun. 6, 2019

(51) Int. Cl. F16K 11/052; F01P 7/14

(52) U.S. Cl. CPC F16K 11/052; F01P 2007/146; F01P 7/14

(57) ABSTRACT

A coolant valve for a powertrain cooling system includes a housing and a valve member. The housing has a chamber, a first inlet port, a second inlet port, and an outlet port. The chamber has a first flat surface, a second flat surface, and a curved surface. The valve member has a first end, a second end opposite the first end, a flat middle portion, and a hinge portion disposed on the first end. The valve member is disposed in one of a first and a second position. When the valve member is disposed in the first position the outlet port is in communication with the first inlet port. When the valve member is disposed in the second position the outlet port is in communication with the second inlet port.

### INTRODUCTION

The present disclosure relates generally to a valve assembly for a vehicle coolant system and more particularly a coolant valve having multiple input sources.

Vehicle manufacturers are incorporating additional capability into their vehicles including hybrid powertrains, stop-start engine control, and smaller turbocharged engines. Alternative powertrains create new challenges to other powertrain subsystems including the cooling system. For example, a cooling system can enable such powertrains by adding multiple sources of pressurized coolant flow. However, incorporating multiple sources of pressurized coolant flow requires additional hardware to create opportunities to improve efficiency, assembly complexity, and diagnostic capability.

Accordingly, there is a need in the art for a coolant valve assembly capable of limiting pressure loss while receiving pressurized coolant from multiple sources to provide improved control, diagnostics, and valve complexity.

### SUMMARY

A coolant valve for a powertrain cooling system is provided comprising a housing and a valve member. The housing has a first inlet port, a second inlet port, and an outlet port. The valve member has a first end, a second end opposite the first end, a flat middle portion, and a hinge portion disposed on the first end. The hinge portion of the valve member is disposed in the housing. The valve member is disposed in one of a first and a second position.

In one example of the present disclosure, when the valve member is disposed in the first position the outlet port is in communication with the first inlet port.

In another example of the present disclosure, when the valve member is disposed in the second position the outlet port is in communication with the second inlet port.

In yet another example of the present disclosure, the housing includes a chamber having a first flat surface, a second flat surface, and a curved surface. A third end of the first flat surface is disposed adjacent to a fourth end of the second flat surface. The curved surface is disposed to connected a fifth end of the first flat surface to a sixth end of the second flat surface.

In yet another example of the present disclosure, the hinge portion of the valve member is disposed between the third end of the first flat surface and the fourth end of the second flat surface.

In yet another example of the present disclosure, the hinge portion of the valve member includes at least a first bearing and a resilient member and the resilient member urges the valve member to one of the first and the second positions.

In yet another example of the present disclosure, the coolant valve further includes a sensor disposed in the housing. The sensor detects when the valve member is in one of the first position and the second position.

In yet another example of the present disclosure, the valve member further includes a pressure relief valve disposed in the middle portion and the pressure relief valve provides for communication between the first inlet port and the second inlet port when the valve member is disposed in the second position.

In yet another example of the present disclosure, the first inlet port is disposed in the first flat surface of the housing and the second inlet port is disposed in the second flat surface of the housing.

Another example of a cooling valve is provided, the coolant valve including a housing and a valve member. The housing has a first inlet port, a second inlet port, and an outlet port. The valve member has a first end, a second end opposite the first end, a flat middle portion, and a hinge portion disposed on the first end. The hinge portion of the valve member is disposed in the housing. The valve member is disposed in one of a first and a second position. When the valve member is disposed in the first position the outlet port is in communication with the first inlet port. When the valve member is disposed in the second position the outlet port is in communication with the second inlet port.

In one example of the present disclosure, the housing includes a chamber having a first flat surface, a second flat surface, and a curved surface. A third end of the first flat surface is disposed adjacent to a fourth end of the second flat surface. The curved surface is disposed to connected a fifth end of the first flat surface to a sixth end of the second flat surface.

In another example of the present disclosure, the hinge portion of the valve member is disposed between the third end of the first flat surface and the fourth end of the second flat surface.

In yet another example of the present disclosure, the hinge portion of the valve member includes at least a first bearing and a resilient member and the resilient member urges the valve member to the second position.

In yet another example of the present disclosure, the coolant valve further includes a sensor disposed in the housing. The sensor detects when the valve member is disposed in the second position.

In yet another example of the present disclosure, the valve member further includes a pressure relief valve disposed in the middle portion of the valve member. The pressure relief valve provides for communication from the chamber of the housing to the second inlet port when the valve member is disposed in the second position.

In yet another example of the present disclosure, the first inlet port is disposed in the first flat surface of the housing and the second inlet port is disposed in the second flat surface of the housing.

Another example of a cooling valve is provided, the coolant valve including a housing and a valve member. The housing has a chamber, a first inlet port, a second inlet port, and an outlet port. The chamber has a first flat surface, a second flat surface, and a curved surface. A third end of the first flat surface is disposed adjacent to a fourth end of the second flat surface. The curved surface is disposed to connected a fifth end of the first flat surface to a sixth end of the second flat surface. The first inlet port is disposed in the first flat surface of the housing. The second inlet port is disposed in the second flat surface of the housing.

The valve member has a first end, a second end opposite the first end, a flat middle portion, and a hinge portion disposed on the first end. The hinge portion of the valve member is disposed in the housing. The valve member is disposed in one of a first and a second position. When the valve member is disposed in the first position the outlet port is in communication with the first inlet port. When the valve member is disposed in the second position the outlet port is in communication with the second inlet port.

In one example of the present disclosure, the hinge portion of the valve member includes at least a first bearing and a resilient member. The resilient member urges the valve member to the second position and is disposed between the third end of the first flat surface and the fourth end of the second flat surface.

In another example of the present disclosure, the coolant valve further includes a sensor disposed in the housing. The sensor detects when the valve member is disposed in the second position.

In yet another example of the present disclosure, the valve member further includes a pressure relief valve disposed in the middle portion of the valve member. The pressure relief valve provides for communication from the chamber of the housing to the second inlet port when the valve member is disposed in the second position.

The above features and advantages and other features and advantages of the present disclosure are readily apparent from the following detailed description when taken in connection with the accompanying drawings.

### BRIEF DESCRIPTION OF THE DRAWING

The drawings described herein are for illustration purposes only and are not intended to limit the scope of the present disclosure in any way.

FIG. 1 is a schematic of a cooling system for a vehicle powertrain according to the principles of the present disclosure;

FIG. 2 is a perspective view of a coolant valve according to the principles of the present disclosure;

FIG. 3 is a side view of a coolant valve according to the principles of the present disclosure;

FIG. 4 is a perspective view of coolant valve according to the principles of the present disclosure;

FIG. 5 is a perspective view of coolant valve according to the principles of the present disclosure; and

FIG. 6 is a side view of a coolant valve according to the principles of the present disclosure.

### DESCRIPTION

The following description is merely exemplary in nature and is not intended to limit the present disclosure, application, or uses.

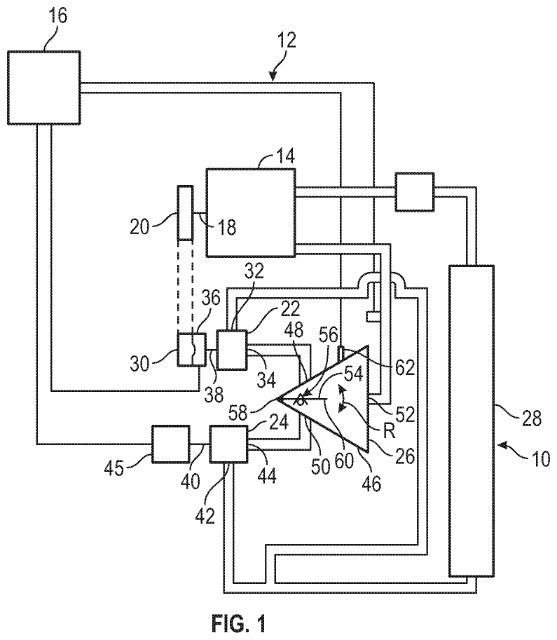

With reference to FIG. 1, a cooling system 10 for a vehicle powertrain 12 is illustrated and will now be described. Along with the cooling system 10, the vehicle powertrain 12 includes an internal combustion engine 14 along with a transmission (not shown), driveline (not shown), and a powertrain control module 16. The cooling system 10 provides a mechanism for removing heat from the engine 14, providing heat for functions such as heating the passenger cabin of the vehicle, and expelling heat to the surrounding environment.

The engine 14 includes an output shaft 18 and a first pulley 20. The output shaft 18 is directly connected for common rotation with both the crankshaft (not shown) and the first pulley 20. While shown as a schematic pulley 20, the first pulley 20 may also be a gear or chain sprocket without departing from the scope of the present disclosure. The first pulley 20 allows for torque transfer between the engine 14 and other accessories of the engine 14 or vehicle powertrain 12.

The cooling system 10 includes a first coolant pump 22, a second coolant pump 24, a coolant valve 26, a radiator 28, and a plurality of other sensors, coolant passages, and accessories that will be described further below. More particularly, the first coolant pump 22 is a mechanical pump having a second pulley 30, an inlet port 32, an outlet port 34, a clutch 36, and an input shaft 38. The second pulley 30 of the first coolant pump 22 is connected to the first pulley 20 of the engine 14 through a belt 40. The clutch 36 is disposed between the pulley 30 and the input shaft 38 to selectively transfer torque from the second pulley 30 to the input shaft 38 as commanded by the powertrain control module 16. The inlet port 32 is connected for downstream coolant supply with the radiator 28. The outlet port 34 is connected to the coolant valve 26 which will be described in more below.

The second coolant pump 24 is also a mechanical pump having an input shaft 40, an inlet port 42, and an outlet port 44. The input shaft 20 is connected directed to an electric motor 45 that is selectively operated by the powertrain control module 16. The inlet port 42 of the second coolant pump 24 is connected for downstream coolant supply with the radiator. The outlet port 44 of the second coolant pump is connected with the coolant valve 26.

The coolant valve 26 is a three-way valve and includes a housing 46 having a first inlet port 48, a second inlet port 50, an outlet port 52, a valve member 54, and a sensor 62. While having just the first and second inlet ports 48, 50 and an outlet port 52, the valve member 54 includes a one-way pressure relief valve 56 that coordinates with the second inlet port 50 to allow excess coolant pressure to bleed out of the coolant valve 26 through the second inlet port 50. Thus, the coolant valve 26 acts as a four-way valve. For example, the valve member 54 has a first end 58 and a second end 60 opposite the first end 58. The first end 58 of the valve member 54 is pivotably disposed in the housing 46 allowing the valve member 54 to rotate R freely depending upon which of the first and second coolant pumps 22, 24 are actively pumping coolant to the coolant valve 26. When the clutch 36 of the first coolant pump 22 is engaged and the engine is running, the first coolant pump 22 provides pressurized coolant to the first inlet port 48 of the coolant valve 26 to the outlet port 52. When the clutch 36 of the first coolant pump 22 is disengaged and the electric motor 45 of the second coolant pump 24 is turned on, the second coolant pump 24 provides pressurized coolant to the second inlet port 50 of the coolant valve 26 to the outlet port 52. The outlet port 52 is connected for pressurized coolant flow with the engine 14. The sensor 62 is disposed in the housing 46 and is electrically connected to the powertrain control module 16 to provide information about the operation of the coolant valve 26. In particular, the sensor 62 detects in which position the valve member 54 is located.

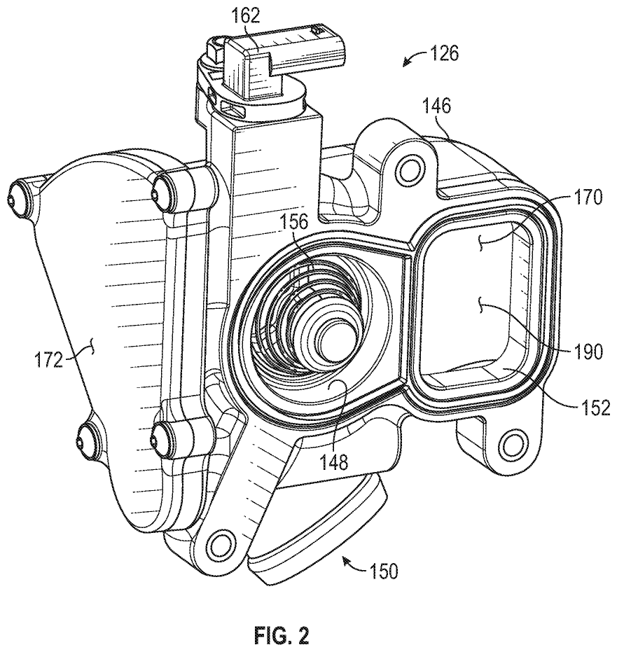

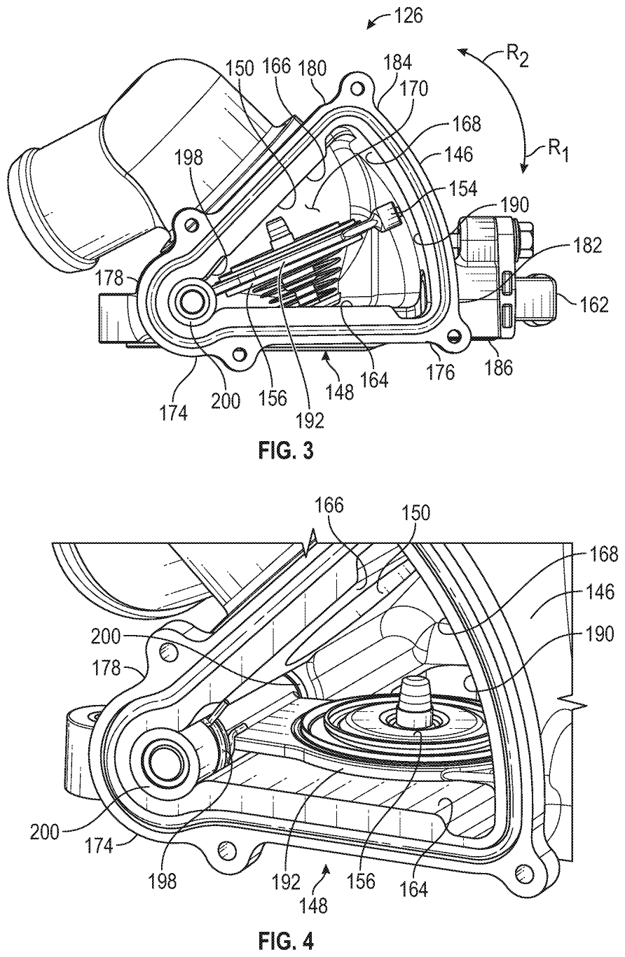

Turning now to FIGS. 2-6 with continuing reference to FIG. 1, a coolant valve 126 of the cooling system 10 is illustrated in various functional positions and will now be described. As described above, the coolant valve 126 includes a housing 146, a valve member 154, and a sensor 162. The housing 146 includes a first wall or surface 164, a second wall or surface 166, a third wall or surface 168, a back wall or surface 170, and a cover 172 (removed in FIGS. 3-6). More particularly, the first wall 164 has a first end 174, a second end 176 opposite the first end 174, a first inlet port 148, and an outlet port 152. The second wall 166 has a first end 178, a second end 180 opposite the first end 178, and a second inlet port 150. The third wall 168 is a curved wall having a first end 182, a second end 184 opposite the first end 182, and a sensor port 186 disposed adjacent to the first end 182 and through which is disposed the sensor 162. The first end 174 of the first wall 164 is combined with the first end 178 of the second wall 166 to form a hinge portion 188 of the housing 146. The second end 176 of the first wall 164 is combined with the first end 182 of the third wall 168 and the second end 180 of the second wall 166 is combined with the second end 184 of the third wall 168. Including the back wall 170 and the cover 172, a valve chamber 190 is formed within the housing 146.

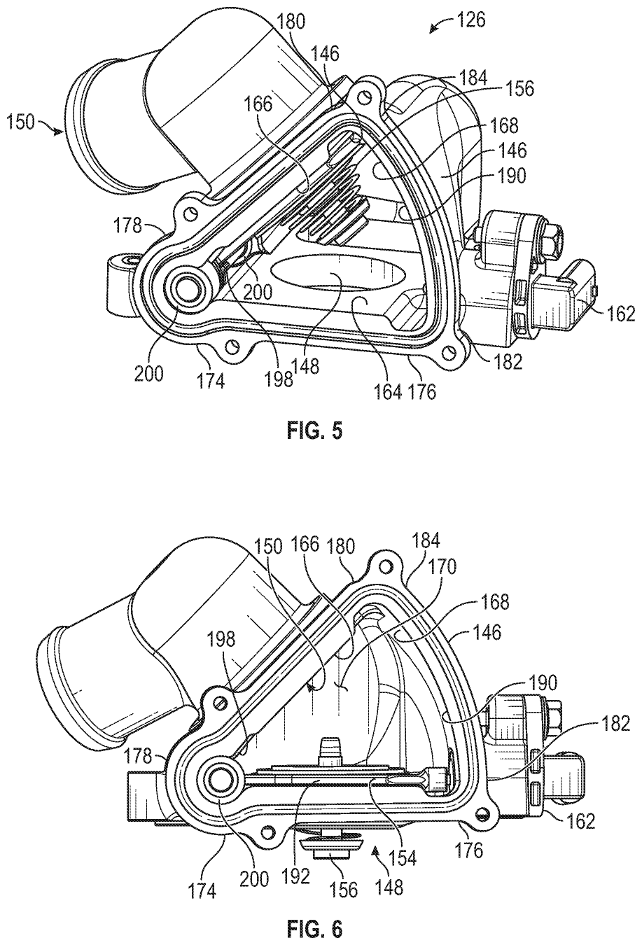

The valve member 154 includes a first end 158, a second end 160 opposite the first end 158, a middle portion 192, a one-way pressure release valve 156 disposed in the middle portion 192, a first surface 194, and a second surface 196. More particularly, the first end 158 of the valve member 154 is pivotably disposed proximate the first ends 174, 178 of the first and second walls 164, 166. In this regard, the valve member 154 is capable of rotating and being disposed in at least a first position (shown in FIGS. 2, 4, and 6) and a second position (shown in FIG. 5). A resilient member or spring 198 is disposed between the valve member 154 and the housing 146 and urges the valve member 154 to be disposed in the first position. Also included is a pair of bearings 200 that provide for lower friction between the rotating valve member 154 and the housing 146. In the present example, the valve member 154 is passively activated using coolant pressure from one of the first and second coolant pumps 22, 24. However, other activation means may be used to actuate the valve member 154 including, for example, a solenoid, a DC motor, or a vacuum actuator without departing from the scope of the present disclosure.

Due to higher pressure in the second inlet port 150 when the second coolant pump 24 is turned on, the valve member 154 rotates clockwise as shown in the perspective of FIG. 3, until the first inlet port 148 is completely sealed by the valve member 154. Also occurring when the valve member 154 is in the first position (shown in FIG. 6) is the sensor 162 detecting the present of the valve member 154. In the present disclosure, the sensor 162 is a Hall sensor, however, other types of proximity sensors may be included in the coolant valve 126 without departing from the scope of the disclosure.

Likewise, due to higher pressure in the first inlet port 148 when the first coolant pump 22 is operating, the valve member 154 rotates counterclockwise R₂ until the second inlet port 150 is completely sealed by the valve member 154. Thus as disclosed in the present example, the valve member 154 is passively activated using coolant pressure from one of the first and second coolant pumps 22, 24. However, other activation means may be used to actuate the valve member 154 including, for example, a solenoid, a DC motor, or a vacuum actuator without departing from the scope of the present disclosure.

The one-way pressure release valve 162 of the middle portion 192 of the valve member 154 preferably only opens when the valve member 154 is disposed in the second position (FIG. 5) and the system coolant pressure exceeds some preselected limit. When the system pressure exceeds the system limit, the one-way pressure release valve 162 opens and bleeds coolant pressure into the second input port 150. Upon the system pressure returning to below or at the system limit, the one-way pressure release valve 162 closes.

While examples have been described in detail, those familiar with the art to which this disclosure relates will recognize various alternative designs and examples for practicing the disclosed structure within the scope of the appended claims.

1. A coolant valve for a powertrain cooling system, the coolant valve comprising:
a housing having a first inlet port, a second inlet port, and an outlet port; and
a valve member having a first end, a second end opposite the first end, a middle portion, and a hinge portion disposed on the first end, wherein the hinge portion of the valve member is disposed in the housing, and wherein the valve member further includes a pressure relief valve disposed in the middle portion; and
wherein the valve member is disposed in one of a first and a second position and the pressure relief valve provides for communication between the first inlet port and the second inlet port when the valve member is disposed in the second position.

2. The coolant valve of claim 1 wherein when the valve member is disposed in the first position the outlet port is in communication with the first inlet port.

3. The coolant valve of claim 2 wherein when the valve member is disposed in the second position the outlet port is in communication with the second inlet port.

4. The coolant valve of claim 1 wherein the housing includes a chamber having a first flat surface, a second flat surface, and a curved surface, and wherein a third end of the first flat surface is disposed adjacent to a fourth end of the second flat surface, and the curved surface is disposed to connect a fifth end of the first flat surface to a sixth end of the second flat surface.

5. The coolant valve of claim 4 wherein the hinge portion of the valve member is disposed between the third end of the first flat surface and the fourth end of the second flat surface.

6. The coolant valve of claim 5 wherein the hinge portion of the valve member includes at least a first bearing and a resilient member and the resilient member urges the valve member to one of the first and the second positions.

7. The coolant valve of claim 1 further including a sensor disposed in the housing, and wherein the sensor detects when the valve member is in one of the first position and the second position.

8. (canceled)

9. The coolant valve of claim 81 wherein the first inlet port is disposed in the first flat surface of the housing and the second inlet port is disposed in the second flat surface of the housing.

10. A coolant valve for a powertrain cooling system, the coolant valve comprising:
a housing having a first inlet port, a second inlet port, and an outlet port; and
a valve member having a first end, a second end opposite the first end, a flat middle portion, and a hinge portion disposed on the first end, wherein the hinge portion of the valve member is disposed in the housing, and wherein the valve member further includes a pressure relief valve disposed in the flat middle portion; and
wherein the valve member is disposed in one of a first and a second position, when the valve member is disposed in the first position the outlet port is in communication with the first inlet port, and when the valve member is disposed in the second position the outlet port is in communication with the second inlet port and the pressure relief valve provides for communication between the first inlet port and the second inlet port when the valve member is disposed in the second position.

11. The coolant valve of claim 10 wherein the housing includes a chamber having a first flat surface, a second flat surface, and a curved surface, and wherein a third end of the first flat surface is disposed adjacent to a fourth end of the second flat surface, and the curved surface is disposed to connected a fifth end of the first flat surface to a sixth end of the second flat surface.

12. The coolant valve of claim 11 wherein the hinge portion of the valve member is disposed between the third end of the first flat surface and the fourth end of the second flat surface.

13. The coolant valve of claim 12 wherein the hinge portion of the valve member includes at least a first bearing and a resilient member and the resilient member urges the valve member to the second position.

14. The coolant valve of claim 10 further including a sensor disposed in the housing, and wherein the sensor detects when the valve member is disposed in the second position.

15. (canceled)

16. The coolant valve of claim 11 wherein the first inlet port is disposed in the first flat surface of the housing and the second inlet port is disposed in the second flat surface of the housing.

17. A coolant valve for a powertrain cooling system, the coolant valve comprising:
a housing having a chamber, a first inlet port, a second inlet port, and an outlet port, and wherein the chamber has a first flat surface, a second flat surface, and a curved surface, a third end of the first flat surface is disposed adjacent to a fourth end of the second flat surface, the curved surface is disposed to connected a fifth end of the first flat surface to a sixth end of the second flat surface, the first inlet port is disposed in the first flat surface of the housing, and the second inlet port is disposed in the second flat surface of the housing; and
a valve member having a first end, a second end opposite the first end, a flat middle portion, and a hinge portion disposed on the first end, wherein the hinge portion of the valve member is disposed in the housing, and wherein the valve member further includes a pressure relief valve disposed in the flat middle portion, and
wherein the valve member is disposed in one of a first and a second position, when the valve member is disposed in the first position the outlet port is in communication with the first inlet port, and when the valve member is disposed in the second position the outlet port is in communication with the second inlet port, and the pressure relief valve provides for communication between the first inlet port and the second inlet port when the valve member is disposed in the second position.

18. The coolant valve of claim 17 wherein the hinge portion of the valve member includes at least a first bearing and a resilient member and the resilient member urges the valve member to the second position and is disposed between the third end of the first flat surface and the fourth end of the second flat surface.

19. The coolant valve of claim 18 further including a sensor disposed in the housing, and wherein the sensor detects when the valve member is disposed in the second position.

20. (canceled)
